(19) United States
(12) Patent Application Publication
(10) Pub. No.: US 2014/0178558 A1
(43) Pub. Date: Jun. 26, 2014

(54) ALCOHOL BEVERAGE CONTAINING FRUIT-JUICE-CONTAINING STORED UNDILUTED SAKE

(71) Applicants: Akira Yoshihiro, Kawasaki-shi (JP); Motoo Kubota, Kawasaki-shi (JP)

(72) Inventors: Akira Yoshihiro, Kawasaki-shi (JP); Motoo Kubota, Kawasaki-shi (JP)

(73) Assignee: SUNTORY HOLDINGS LIMITED, Osaka-shi, Osaka (JP)

(21) Appl. No.: 14/113,662

(22) PCT Filed: Apr. 3, 2012
(86) PCT No.: PCT/JP2012/059028

§ 371 Date: Jan. 2, 2014

(30) Foreign Application Priority Data
Apr. 25, 2011 (JP) 2011-097680

(51) Int. Cl. C12G 3/04

(52) U.S. Cl. CPC C12G 3/04
USPC 426/592

(57) ABSTRACT

The object of the present invention is to provide an alcohol beverage that simultaneously achieves the rich flavor of the fruit juice component and regulates the precipitation and flavor deterioration associated with long term storage. The effects of endowing a rich flavor from a fruit juice component to the alcohol beverage and effectively regulating the precipitation and flavor deterioration caused by storing the beverage for a long time results from using a stored base liquid obtained by mixing an alcohol and a fruit juice to achieve a mixture whose alcohol by volume is 13 to 20 v/v %, then storing the mixture.

### TECHNICAL FIELD

The present invention relates to an alcohol beverage having an improved stability of quality. Specifically, the invention relates to an alcohol beverage whose deterioration in appearance and deterioration in flavor are improved due to an inclusion of a fruit-juice-containing base liquor, in which the base liquor is obtained by mixing an alcohol and a fruit juice followed by storing the mixture for a long time.

### BACKGROUND ART

Many commercially available container-packaged alcohol beverages are characterized by fruit savor. Since sufficient fruit savor cannot be achieved just by including flavoring agents in the fruit-savored, container-packaged alcohol beverages, fruit juices are added to achieve ample fruit savor (refer to Patent Documents 1 to 4).

Generally speaking, a container-packaged alcohol beverage is rarely consumed immediately after production, and is frequently stored in the distribution channel or the market for some time. For example, an alcohol beverage having a low alcohol by volume (RTD product: Ready to Drink) may be retained in the market for a long time after production until it is purchased by a consumer. Further, liquors with a high alcohol by volume are frequently consumed in small portions as an ingredient of cocktails, so they are stored for a long time from the time of purchase and decapping until full consumption, under normal temperature. A further incorporation of the market retention time preceding the purchase results is an extremely long storage period from the time of production.

Such long storage period from the time of production to consumption may cause undesirable degradation in the quality of the fruit juice component. That is, the product value may decrease considerably due to an impairment in the appearance of the product from precipitation, or to a development of an off flavor or the weakening of taste caused by thermal degradation of the fruit juice component.

### CITATION LIST

### Patent Documents

Patent Document 1: Japanese patent unexamined publication No. 2009-195125

Patent Document 2: Japanese patent unexamined publication No. 2009-195122

Patent Document 3: Japanese patent unexamined publication No. 2009-153483

Patent Document 4: Japanese patent unexamined publication No. 2000-312580

### Technical Problem

As described above, it is important to improve stability of quality associated with the fruit juice component in an alcohol beverage comprising fruit juice. However, limiting the amount of fruit juice to be added to avoid quality deterioration by the fruit juice component is likely to lead to an alcohol beverage with an unsatisfactory quality in terms of richness of fragrance or taste. Hence, it was difficult to develop a technology for fruit-savored container-packaged alcohol that achieves both the rich flavor of the fruit juice component and the prevention of quality deterioration from the time of production to the time the beverage is drunk by a consumer.

The object of the present invention in view of the above problem is to provide an alcohol beverage that simultaneously achieves the rich flavor of the fruit juice component and regulates the precipitation and deterioration of flavor associated with long term storage.

### Solution to Problem

The present inventors conducted extensive study of the above problem to find that the use of a stored base liquor, obtained by mixing a fruit juice and an alcohol and storing the mixture for a long time, adds a rich flavor of fruit juice to the alcohol beverage, while effectively regulating precipitation and deterioration of flavor in the alcohol beverage for a long time after production, and thus, completed the invention.

That is, the present invention encompasses the following embodiments without being limited thereby.
(1) A method for manufacturing a container-packaged alcohol beverage comprising the steps of:

mixing a fruit juice and an alcohol whose alcohol by volume is 59 v/v % or higher to achieve a mixture whose alcohol by volume is 13 to 20 v/v %, and storing the mixture for 1 to 36 months;

removing an insoluble solid matter from the stored mixture to obtain a stored base liquor;

adding the stored base liquor to prepare an alcohol beverage; and

filling the prepared alcohol beverage into a container.
(2) The method according to (1), wherein the mixture has a Brix value of 4 to 40.
(3) The method according to (1) or (2), wherein the alcohol includes spirit.
(4) The method according to any one of (1) to (3), wherein the fruit juice is grape juice and/or citrus juice.
(5) The method according to any one of (1) to (4), wherein the fruit juice has a Brix value of 6 to 70.
(6) A container-packaged alcohol beverage obtained by: mixing a fruit juice and an alcohol whose alcohol by volume is 59 v/v % or higher to achieve a mixture whose alcohol by volume is 13 to 20 v/v %, and storing the mixture for 1 to 36 months, and adding a stored base liquor that has been obtained by removing an insoluble solid matter from the stored mixture.
(7) A container-packaged alcohol beverage manufactured by the method of (1) to (5).
(8) A method for improving preservability of an alcohol beverage comprising the steps of:

mixing a fruit juice and an alcohol whose alcohol by volume is 59 v/v % or higher to achieve a mixture having an alcohol by volume of 13 to 20 v/v %, and storing the mixture for 1 to 36 months;

removing an insoluble solid matter from the stored mixture to obtain a stored base liquor; and

adding the stored base liquor to prepare an alcohol beverage.

### Advantageous Effect of Invention

The present invention provides an alcohol beverage having a rich flavor derived from fruit juice, while regulating the deterioration in appearance from precipitation and the like as well as the deterioration of the flavor quality for long term storage under normal temperature after production.

### DESCRIPTION OF EMBODIMENTS

Alcohol Beverage

The present invention relates to an alcohol beverage and a production method thereof. The alcohol beverage of the present invention refers to a beverage that contains alcohol, and the alcohol concentration is not particularly limited. The alcohol beverage of the present invention includes, for example, a so-called low alcohol beverage (RTD product) which has an alcohol by volume of about 1 to 9 v/v %, or a so-called liquor which as an alcohol by volume of 15 v/v % or higher. The alcohol by volume of the alcohol beverage of the present invention is preferably 0.1 to 60 v/v %, and more preferably 1 to 30 v/v %, and even more preferably 3 to 20 v/v %.

The alcohol beverage of the present invention includes the fruit-juice-containing stored base liquor, described below. The fruit-juice-containing stored base liquor has a rich flavor derived from fruit juice, since it contains fruit juice; the incorporation of the base liquor into the alcohol beverage endows the alcohol beverage with a rich flavor derived from fruit juice; and the base liquor can be used to replace a part or all of a fruit juice. Further, by incorporating the fruit-juice-containing stored base liquor, the stability of quality of the alcohol beverage during long term storage can be largely improved compared to the alcohol beverage that simply comprises fruit juice. Specifically, an amount of fruit juice that would precipitate when simply added to the alcohol beverage can be added as a fruit-juice-containing stored base liquor to produce an alcohol beverage having the same level of fruit juice content while exhibiting reduced precipitation during long term storage and maintaining a rich flavor quality for a long time. Further, the fruit-juice-containing stored base liquor of the present invention has a flavor component that is stabilized during storage, so the incorporation of the base liquor into the final alcohol beverage enables a stable flavor to be maintained for a long time after production. The action mechanism of the present invention is unknown, but it is presumed without being limited thereby that the effect is due to a chemical or a physical change of the flavor component in the fruit juice during the storage period, for example, esterification with alcohol, while insoluble solid matters contained in the fruit juice appeared as precipitates.

Accordingly, the present invention can largely improve long term stability, so the effect of the present invention can be fully exploited when applied to a container-packaged alcohol beverage, which is often stored for a long time. The shape and material of the container are not limited in any way, and containers of resin, paper, glass or wood can be preferably used; examples of the container include a molded container mainly composed of plastic, a metal can, a laminated paper container laminated with a metal foil or plastic film, and a glass bottle. In a preferable embodiment, the alcohol beverage of the present invention can be filled in a resin container, a laminated paper container or a glass container.

Fruit-Juice-Containing Stored Base Liquor

The fruit-juice-containing stored base liquor of the present invention can be obtained by mixing a fruit juice and an alcohol, then storing the mixture for a predetermined time. Specifically, the fruit-juice-containing stored base liquor is produced by mixing a fruit juice and an alcohol whose alcohol by volume is 59 v/v % or higher to achieve a mixture whose alcohol by volume is 13 to 20 v/v %, and storing the mixture for 1 to 36 months thereafter; and removing an insoluble solid matter from the stored mixture to obtain a base liquor.

The fruit juice to be used in the fruit-juice-containing stored base liquor can be any fruit juice normally used to produce a beverage without being limited thereby. The type of fruit to be used as a raw material of fruit juice is not particularly limited either, and can be selected freely according to the designed quality of the target alcohol beverage. Examples of fruit juices include those of citrus (Citrus) (orange, satsuma mandarin, lemon, grapefruit, lime, mandarin orange, yuzu, tangerine, temple orange, tangelo, calamansi), apple, grape, peach, pineapple, guava, banana, mango, acerola, prune, papaya, passion fruits, Japanese apricot, Japanese pear, apricot, lychee, melon, pear, prunes, and preferable fruit juices in view of endowing a rich flavor to alcohol beverage are those of citrus, apple, grape, peach and the like.

Further, there is no particular limitation concerning the production method and distribution of the fruit juice. For example, any of the following fruit juices can be used: a non-concentrated straight fruit juice, concentrated fruit juice, puree fruit juice, transparent fruit juice, opaque fruit juice, semi-opaque fruit juice. In the present invention, not only an unprocessed fruit juice, but also a fruit juice that has been subjected to processes, such as separation of an insoluble solid matter, concentration, refinement, dilution or heating can be used, and the concentration method can be any of depressurized concentration, freeze-concentration or reverse osmosis membrane concentration, and an enzyme-processed fruit juice can be preferably used as well. To regulate precipitation of insoluble components during long term storage, it is preferable to use a processed fruit juice whose insoluble solid matter has been separated by filtering, etc. Further, fruit juices consisting of a mixture of two or more of the above various fruit juices can also be used.

The fruit juice used in the stored base liquor of the present invention should preferably have a sugar refractometer index (Brix value) of 6 to 70. Further, a large pulp portion may reduce workability by producing an excessive amount of precipitates or cause acridity during storage, so the pulp portion in a fruit juice should preferably be 10 v/w % or lower and more preferably 5 v/w % or lower. The amount of pulp portion in a fruit juice can be measured as follows. The fruit juice weighed precisely is introduced into a spitz tube marked with a scale indicating the volume, then pure water is added to obtain a mixture of about 10 ml, after which the mixture is thoroughly mixed. After the mixture is subjected to centrifugal separation at 20° C. and 300 rpm for 15 minutes, the volume of the precipitated solid matter is read. The volume of the solid matter is divided by the preliminary measured weight of the fruit juice, and the result in percent figures is seen as the solid matter amount of the sample (v/w %). For example, when a fruit juice of 3.0 g subjected to centrifugal separation at the above condition produces precipitates of 1.8 ml, the obtained pulp portion amount is 1.8 (ml)/3.0 (g)×100=60 (v/w %).

An alcohol used in the fruit-juice-containing stored base liquor of the present invention can be any kind of alcohol used commonly in beverages (generally referred to as alcoholic beverages) without being limited thereby. There is no limitation to the raw materials, production method or other process methods.

The alcohol by volume of an alcohol is determined as 59 v/v % or higher, since such level is advantageous in removing insoluble components and generating flavor components, but it should preferably be 70 v/v % or higher, and more preferably 80 v/v % or higher. An alcohol by volume below 59 v/v % may result in insufficient removal of insoluble components and insufficient generation of flavor components. There is no upper limit to the alcohol by volume, but when considering that the alcohol by volume of an alcohol obtained by distillation is generally 96 v/v % or lower, and that the use of pure ethyl alcohol may result in the flavor being insufficient, the alcohol by volume should preferably be 96 v/v % or lower. It is preferable to include at least one alcoholic beverage having a high alcohol by volume, since the alcohol by volume after mixing in the present invention, achieved by mixing a fruit juice and an alcohol, is 13 to 20 v/v % as mentioned below.

Any type of alcohol is allowable as long as it is brewed alcohol, and a single type of alcohol or multiple types of alcohols may be use. Examples of preferable alcohols to be used in the present invention include brewed alcohol, such as Japanese sake, wine, beer, and distilled alcohol, such as whiskey, vodka, rum, shochu, and spirits, but distilled alcohols are preferable from the view point of long term stability. Of distilled alcohols, the continuously distilled alcohol obtained by distillation of an alcohol-containing matter in the continuous still may be preferably used. Examples of such continuously distilled alcohol include raw material alcohol or continuously distilled shochu (the so-called kourui shochu [high-grade shochu]).

The alcohol by volume of the present invention can be measured by the method in the National Tax Agency Predetermined Analysis Method Law (National Tax Agency Instruction No. 6, 2007, revised on Jun. 22, 2007). Specifically, it can be obtained by preparing a sample whose carbonic acid gas is removed as necessary by filtration or ultrasonic wave, distilling the sample by direct fire, measuring the density of the obtained stationary liquid at 15° C. by a vibrating densimeter, then converting the value using “Table 2 Conversion Table of Alcohol and Density (15° C.) and Specific Gravity (15/15° C.),” which is a table attached to the National Tax Agency Predetermined Analysis Method Law.

In addition, flavoring agents, saccharides or acidulants may be added to the fruit-juice-containing stored base liquor in an amount that does not inhibit the effect of the present invention.

In the present invention, a fruit juice and an alcohol whose alcohol by volume is 59 v/v % or higher are mixed to achieve a mixture whose alcohol by volume is 13 to 20 v/v %. When mixing the fruit juice and the alcohol, the order of introducing the raw materials can start from the fruit juice or the alcohol, determined in view of workability. When mixing the materials, the materials should preferably be agitated to achieve as uniform a mixture as possible. Agitation can be performed by any well known agitation means, and any means can be performed without particular limitation, whether it be machine agitation or air agitation.

The mixture of the fruit juice and alcohol after agitation in the present invention should have an alcohol by volume of 13 to 20 v/v %, and more preferably 14 to 18 v/v %. When the alcohol by volume in the mixture is too low, it becomes difficult to effectively remove the insoluble component in the storing step, and the risk of precipitation in the final product, that is, the alcohol beverage, increases, so a low alcohol by volume is not preferable. On the other hand, an excessively high alcohol by volume in the mixture can lead to a loss of the richness of flavor in the alcohol beverage, so it is not preferable.

Although the fruit juice concentration is not particularly limited in the present invention, as long as the alcohol by volume of the mixture is adjusted to the above range, it is preferable to set the fruit juice concentration in the mixture to a specific range, since such range endows a rich savor to the final product, that is, the container-packaged alcohol beverage, and effectively suppresses the risk of precipitation. The fruit juice concentration of the mixture can be controlled by the Brix value, and the Brix value should preferably be in the range of 4 to 40, more preferably in the range of 4 to 35, and even more preferably in the range of 4 to 30.

A known means can be used as the method for measuring the Brix of the mixture, and the Brix is measured by a sugar refractometer (also known as the Brix meter). If the measured Brix value is excessively high and exceeds the measurement range of the sugar refractometer, the mixture can be appropriately diluted with pure water to measure, then dividing the measured value by the dilution rate. The dilution rate is shown by the volume rate (v/v %) of the mixture and pure water.

The respective ratio of the fruit juice and the alcohol is not particularly limited, but it is preferable to make adjustments as necessary so that the alcohol by volume after mixing is in a certain range.

The obtained mixture of the fruit juice and the alcohol is stored for 1 to 36 months in the present invention. The storage can be performed by a well known means and the means can be selected according to the designed quality of the subject container-packaged alcohol beverage. For example, the mixture can be stored in containers including a tank, or it can be stored in wooden barrels made of oak, etc. The mixture should preferably be stored in a tank of stainless or enamel to emphasize the savor of fruit, and it should preferably be stored in a barrel to endow a wooden fragrance.

The storage temperature is not particularly limited, and the storage can preferably be at a normal temperature (e.g. 0 to 40° C. at night temperature), and more preferably at 10 to 40° C. Further, the mixture should preferably be preserved in a shaded state to regulate deterioration by light during storage.

The storage period of the mixture needs to be 1 month or longer. A period shorter than 1 month makes it difficult to endow sufficient rich flavor to the stored base liquor, and the insoluble components may not be sufficiently removed. The maximum storage period is 36 months, since an excessively long storage is likely to produce a deteriorative odor. The storage period is preferably 6 to 36 months, and more preferably 12 to 36 months.

When the storing step completes, the insoluble solid matter is removed from the mixture to obtain a fruit-juice-containing stored base liquor. Depending on how much insoluble solid matter is produced, the insoluble solid matter is removed by racking and other means when only a small amount of insoluble solid matter is produced, and the insoluble solid matter is removed using a solid-liquid separation means when there are much insoluble solid matter. Possible solid-liquid separation means include normal separation methods, such as centrifugal separation, membrane filtration, diatomaceous earth filtration, filter paper filtration, which can be performed alone or by combining multiple means. It is also possible to combine other solid-liquid separation means as a preliminary filtration to improve work efficiency.

Production of Alcohol Beverages

In the present invention, the container-packaged alcohol beverage of the present invention is produced by adding a fruit-containing stored base liquid, produced by the above process, according to the desired designed quality to prepare the alcohol beverage and filling the alcohol beverage in a container.

The raw material of the alcohol beverage of the present invention is not particularly limited except for the above fruit-containing stored base liquor, and various additives, such as fruit juice, alcohol, sugar, and acidulant, can be added as done similarly in a normal alcohol beverage. Various additives that can be added include flavoring agents, Vitamins, colorants, antioxidants, emulsifiers, food preservatives, seasonings, extracts, pH adjusters, and quality stabilizers.

Further, a carbonic acid gas can be added to the alcohol beverage of the present invention to produce a carbonic acid gas beverage.

In addition, from a different view point, the present invention can be understood as a method to improve the preservability of an alcohol beverage. That is, the present invention can be understood as a method for regulating precipitation in a fruit-juice containing alcohol beverage, and a method for regulating flavor deterioration in a fruit-juice-containing alcohol beverage, since the present invention can regulate precipitation and flavor deterioration in a fruit-juice-containing alcohol beverage that has been stored for a long time. Specifically, the method of the present invention comprises the steps of: mixing fruit juice and an alcohol whose alcohol by volume is 59 v/v % or higher to achieve a mixture whose alcohol by volume is 13 to 20 v/v %, and storing the mixture for 1 to 36 months; removing an insoluble solid matter from the stored mixture to obtain a base liquor; and adding the base liquor to prepare an alcohol beverage.

### EXAMPLES

The present invention is described in detail by the Examples below, without being limited thereby.

Production of Fruit-Juice-Containing Stored Base Liquor

A neutral spirit (NS 96, continuous distillation alcohol) whose alcohol by volume is 96 v/v % and a transparent muscat juice (straight type, Brix value: 26, pulp portion: 0.1%) were mixed based on the table of respective composition shown in Table 1 and agitated to form a uniform mixture (alcohol by volume: 15 v/v %, Brix value: 26.5). Then, the alcohol mixed with fruit juice is filled into an oak barrel, and stored for 12 months under the atmosphere at a normal temperature. Then, diatomaceous earth filtration was performed to remove an insoluble solid matter to obtain a fruit-juice-containing stored base liquor having an alcohol by volume of about 15 v/v %.

TABLE 1
Table of Respective Composition of Fruit Juice and Alcohol

| | Alcohol | Compositional |
|---|---|---|
| | by volume | Amount |
| Fruit Juice | — | 84 L |
| NS96 | 96 | 16 L |
| | | 100 L |

Production of Alcohol Beverage

The fruit-juice-containing stored base liquor and the like produced above were added according to the table of respective composition shown in Table 2 to produce an alcohol beverage having an alcohol by volume of 15%. A grape spirit base liquor, which is a continuous distillation alcohol made from grape (alcohol by volume 96%), liquid sugar (Product name IF 55, Kato Kagaku Co. Ltd.), malic acid and citric acid (Maruzen Chemicals Co., Ltd.), and a flavoring agent were used other than the above stored base liquor.

The alcohol beverage at an amount of 350 ml was filled into a container (glass bottle of 360 ml), and a container-packaged alcohol beverage having a muscat flavor (Sample 1) was produced.

TABLE 2
Table of Respective Composition of Alcohol Beverage

| | Alcohol | Compositional | |
|---|---|---|---|
| | by volume | Amount | |
| fruit-juice-containing | 15 | 240 | L |
| stored base liquor | | | |
| grape spirits base liquor | 96 | 120 | L |
| IF55 | — | 180 | kg |
| malic acid | — | 5 | kg |
| citric acid | — | 1 | kg |
| flavoring agent | — | 7 | L |
| water | — | Remnant | |
| total | — | 1000 | L |

The control alcohol beverages (Samples 2 to 9) were produced by the following process. Fruit juice and a neutral spirit (NS 96, continuous distillation alcohol) whose alcohol by volume is 96 v/v % were mixed based on the table of respective composition shown in Table 3 and agitated to form a uniform mixture. The Brix values of the mixtures in the Control Samples 2 to 9 were respectively 33, 27, 26, 11, 19, 16, 9, and 6. The mixtures were not stored, but liquid sugar (Product name IF 55, Kato Kagaku Co. Ltd.), malic acid and citric acid (Maruzen Chemicals Co., Ltd.), and a flavoring agent were appropriately added to it according to the table of respective composition shown in Table 3, and the alcohol beverage of 350 ml was filled into a container (360 ml glass bottle) to produce container-packaged alcohol beverage Samples 2 to 9.

TABLE 3
Table of Respective Component of Control Alcohol Beverages

| | Alc | | Sample | Sample | Sample | Sample | Sample | Sample | Sample | Sample |
|---|---|---|---|---|---|---|---|---|---|---|
| | Content | | 2 | 3 | 4 | 5 | 6 | 7 | 8 | 9 |
| Type of | | | Grape- | cassis | Grape- | Lemon | Grape- | Kyoho | lychee | Peach |
| fruit juice | | | fruit | | fruit | | fruit | grapes | | |
| Fruit juice | | | 63 | 65 | 63 | 35 | 63 | 55 | 60 | 40 |
| BRIX | | | | | | | | | | |
| NS96 | 96 | L | 188 | 188 | 146 | 250 | 250 | 146 | 208 | 188 |
| IF55 | — | kg | 200 | 200 | 200 | 200 | 200 | 200 | 200 | 200 |
| malic acid | — | kg | 0 | 0 | 0 | 0 | 0 | 2 | 0 | 5 |
| citric acid | — | kg | 8 | 7 | 7 | 7 | 7 | 7 | 4 | 1 |
| Flavoring | — | L | 7 | 7 | 7 | 7 | 7 | 7 | 7 | 7 |
| agent | | | | | | | | | | |
| water | — | | remnant | remnant | remnant | remnant | remnant | remnant | remnant | remnant |
| total | | L | 1000 | 1000 | 1000 | 1000 | 1000 | 1000 | 1000 | 1000 |

Evaluation of the Alcohol Beverage

The container-packaged alcohol beverage of the present invention (Sample 1) and the control liquor samples (Samples 2 to 9), having adjusted amounts of fruit juice and alcohol by volumes by the use of different fruit juices, are stored for a certain period, then a sensory evaluation was performed.

First, the above samples were stored in incubators of 5° C. and 50° C. for 12 days, of which the storage at 50° C. was an acceleration test.

The stored samples were subjected to a sensory evaluation concerning the following items by 3 trained, expert panelists. The sum of the rating consisting of the following 3 items formed a comprehensive evaluation.

### (1) Change in Color Tone

The samples stored at 5° C. in Samples 1 to 9 were used as the control to visually evaluate the samples stored at 50° C. The basis for evaluation is as shown below.
1 Point: “Strong browning is observed, and the sample is not acceptable as a product.”
2 Points: “Browning is observed, but the sample is acceptable as a product.”
3 Points: “No change in the color tone is observed.”

### (2) Deterioration of Flavor

The samples stored at 5° C. in Samples 1 to 9 were used as the control to evaluate the deterioration of flavor of the samples stored at 50° C. The basis for evaluation is as shown below.
1 Point: “Strong deteriorative odor is detected, and the sample is not acceptable as a product.”
2 Points: “Deteriorative odor is detected, but the sample is acceptable as a product.”
3 Points: “No deteriorative odor is detected.”

### (3) Precipitation

The samples stored at 5° C. in Samples 1 to 9 were used as the control to visually evaluate the precipitation of the samples stored at 50° C. The basis for evaluation is as shown below.
1 Point: “A large amount of precipitates are observed, and the sample is not acceptable as a product.”
2 Points: “Some precipitates are observed, but the sample is acceptable as a product.”
3 Points: “No precipitation is observed.”

TABLE 4
Evaluation Result of Alcohol Beverages

| | | FruitJuice | Alc. | Color | | Conden- | |
|---|---|---|---|---|---|---|---|
| | | Amount | Content | Tone | Flavor | sation | Comp. |
| | Fruit Juice Used | (v/v %) | (v/v %) | Change | Change | Change | Evaluation |
| Sample 1 | Muscat juice | 20.0 | 15 | 3 | 3 | 3 | 9 |
| Sample 2 | Grapefruit juice | 20.0 | 18 | 1 | 1 | 2 | 4 |
| Sample 3 | Cassis juice | 13.0 | 18 | 1 | 2 | 2 | 5 |
| Sample 4 | Grapefruit juice | 10.0 | 14 | 1 | 1 | 2 | 4 |
| Sample 5 | Lemon juice | 10.0 | 24 | 1 | 1 | 1 | 3 |
| Sample 6 | Grapefruit juice | 10.0 | 24 | 1 | 1 | 1 | 3 |
| Sample 7 | Kyoho grape juice | 5.9 | 14 | 1 | 2 | 3 | 6 |
| Sample 8 | Lychee juice | 3.5 | 20 | 1 | 1 | 3 | 5 |
| Sample 9 | Peach juice | 3.0 | 18 | 2 | 2 | 2 | 6 |

Table 4 shows the evaluation result. The degree of change in the appearance, such as a color tone change and precipitation, and also in the deterioration of flavor, is significantly small in Sample 1, which is the container-packaged alcohol beverage of the present invention, showing that the stability of quality is improved largely in long term storage as well.

1. A method for manufacturing a container-packaged alcohol beverage comprising the steps of:
mixing a fruit juice and an alcohol whose alcohol by volume is 59 v/v % or higher to achieve a mixture whose alcohol by volume is 13 to 20 v/v %, and storing the mixture for 1 to 36 months;
removing an insoluble solid matter from the stored mixture to obtain a stored base liquor;
adding the stored base liquor to prepare an alcohol beverage; and
filling the prepared alcohol beverage into a container.

2. The method according to claim 1, wherein the mixture has a Brix value of 4 to 40.

3. The method according to claim 1, wherein the alcohol includes spirit.

4. The method according to claim 1, wherein the fruit juice is grape juice and/or citrus juice.

5. The method according to claim 1, wherein the fruit juice has a Brix value of 6 to 70.

6. A container-packaged alcohol beverage obtained by: mixing a fruit juice and an alcohol whose alcohol by volume is 59 v/v % or higher to achieve a mixture whose alcohol by volume is 13 to 20 v/v %, and storing the mixture for 1 to 36 months, and adding a stored base liquor that has been obtained by removing an insoluble solid matter from the stored mixture.

7. A container-packaged alcohol beverage manufactured by the method of claim 1.

8. A method for improving preservability of an alcohol beverage comprising the steps of:
mixing a fruit juice and an alcohol whose alcohol by volume is 59 v/v % or higher to achieve a mixture whose alcohol by volume is 13 to 20 v/v %, and storing the mixture for 1 to 36 months;
removing an insoluble solid matter from the stored mixture to obtain a stored base liquor; and
adding the stored base liquor to prepare an alcohol beverage.
